(19) United States
(12) Patent Application Publication
(10) Pub. No.: US 2007/0117014 A1
(43) Pub. Date: May 24, 2007

(54) POSITIVE ELECTRODE ACTIVE MATERIAL FOR LITHIUM SECONDARY BATTERY AND METHOD FOR PRODUCING SAME

(75) Inventors: Naoshi SAITO, Chigasaki-shi (JP); Kazushige Horichi, Chigasaki-shi (JP); Megumi Uchida, Chigasaki-shi (JP); Takeshi Kawasato, Chigasaki-shi (JP); Manabu Suhara, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Seimi Chemical Co., Ltd., Chigasaki-shi (JP)

(21) Appl. No.: 11/625,060

(22) Filed: Jan. 19, 2007

Related U.S. Application Data
(63) Continuation of application No. PCT/JP05/13325, filed on Jul. 20, 2005.

(30) Foreign Application Priority Data
Jul. 20, 2004 (JP) 2004-212078

(51) Int. Cl. H01M 4/58; H01M 4/52; C01G 51/00; C01G 51/04

(52) U.S. Cl. 429/231.3; 429/231.5; 429/231.6; 423/594.6

(57) ABSTRACT

It is to provide a cathode active material for a lithium ion secondary battery, which has high safety, a high discharge voltage, a large capacity and excellent cyclic durability, and a process for producing it. A cathode active material for a lithium secondary battery, characterized by comprising a particulate lithium cobalt composite oxide represented by the formula
LiₐCo_{b}Al_{c}Mg_{d}AₑO_{f}F_{g} (1) (wherein A is Ti, Nb or Ta, O.90≦a≦1.10, 0.97≦b≦1.00, 0.000l≦c≦0.02, 0.000l≦d≦0.02, 0.000l≦e≦0.01, 1.98≦f≦2.02, 0≦g≦0.02, and 0.0003≦c+d+e≦0.03).

### BACKGROUND OF THE INVENTION

1. Field of the Invention

The present invention relates to a cathode active material for a lithium ion secondary battery, which particularly has high safety, a high discharge voltage, a large capacity and high cyclic properties, and its production process.

2. Discussion of Background

Recently, as the portability and cordless tendency of various instruments have progressed, a demand for a non-aqueous electrolyte secondary battery which is small in size and light in weight and has a high energy density, has been increasingly high, and development of a non-aqueous electrolyte secondary battery having excellent properties has been desired more than ever. As a cathode active material for the non-aqueous electrolyte secondary battery, e.g. LiCoO₂, LiNiO₂ or LiMn₂O₄ has been used, and particularly LiCoO₂ has been widely used in view of its safety, capacity, etc. This material functions as a cathode active material in such a manner that lithium in the crystal lattice becomes lithium ions and leaves into the electrolytic solution by charging, and lithium ions are reversibly inserted from the electrolytic solution to the crystal lattice by discharging.

There has been an attempt to improve the cell properties by doping LiCoO₂ with at least 5 mol % of titanium, but the safety was unsatisfactory (Japanese Patent No. 3,797,693). Further, there has been an attempt to improve the battery properties by adding both aluminum and magnesium to LiCoO₂, but the discharge voltage was low, and the durability for charge and discharge cycles was unsatisfactory (WO2002/54512 and JP-A-2004-47437) Further, there has been an attempt to improve the battery properties by adding all of titanium, magnesium and fluorine to LiCoO₂, but the safety was unsatisfactory (JP-A-2002-352802).

### SUMMARY OF THE INVENTION

Under these circumstances, it is an object of the present invention to provide a cathode active material for a lithium ion secondary battery, which has high safety, a high discharge voltage, a large capacity and excellent cyclic durability, and its production process.

The present inventors have conducted extensive studies to achieve the above object and as a result, they have found that a cathode active material for a lithium secondary battery comprising a particulate lithium cobalt oxide composite oxide containing specific amounts of Ti, Nb, and/or Ta, Al and Mg, and as the case requires, further containing fluorine, has high performance positive electrode properties with all of the safety, the cyclic charge and discharge properties, a high discharge voltage and high packing property.

The present inventors have further found that it is preferred to let the above Ti, Nb and/or Ta be present on the surface of the particulate lithium cobalt oxide composite oxide, whereby the effect by these elements will be effectively brought about.

Namely, the present invention is essentially directed to the following.
(1) A cathode active material for a lithium secondary battery, characterized by comprising a particulate lithium cobalt composite oxide represented by the formula
   LiₐCo_{b}Al_{c}Mg_{d}AₑO_{f}F_{g} (1)
   (wherein A is Ti, Nb or Ta, 0.90≦a≦1.10, 0.97≦b≦1.00, 0.0001≦c≦0.02, 0.0001≦d<0.02, 0.0001≦e≦0.01, 1.98≦f≦2.02, 0≦g≦0.02, and 0.0003≦c+d+e≦0.03).
(2) The cathode active material for a lithium secondary battery according to the above (1), wherein in the formula (1), 0.5≦c/d≦2, and 0.002≦c+d≦0.025.
(3) The cathode active material for a lithium secondary battery according to the above (1) or (2), wherein in the formula (1), 0.01≦e/d≦1, and 0.002≦e+d≦0.02.
(4) The cathode active material for a lithium secondary battery according to any one of the above (1) to (3), wherein the element A is unevenly present on the surface of the particulate lithium cobalt composite oxide.
(5) The cathode active material for a lithium secondary battery according to any one of the above (1) to (4), wherein the element F is present on the surface of the particulate lithium cobalt composite oxide.
(6) The cathode active material for a lithium secondary battery according to any one of the above (1) to (5), wherein at least some of Al, Mg and the element A is in the form of a solid solution having cobalt atoms of the lithium cobalt composite oxide particles substituted.
(7) The cathode active material for a lithium secondary battery according to any one of the above (1) to (6), is wherein the amount of Al contained as a single oxide is at most 20 mol % of the entire Al contained in the lithium cobalt composite oxide.
(8) The cathode active material for a lithium secondary battery according to any one of the above (1) to (7), wherein the particulate lithium cobalt composite oxide has a press density of from 3.0 to 3.4 g/cm³.
(9) A process for producing a cathode active material for a lithium secondary battery comprising a particulate lithium cobalt composite oxide represented by the formula
   LiₐCo_{b}Al_{c}Mg_{d}AₑO_{f}F_{g} (1)
   (wherein A is Ti, Nb or Ta, 0.90≦a≦1.10, 0.97≦b≦1.00, 0.0001≦c≦0.02, 0.0001≦d≦0.02, 0.0001≦e≦0.01, 1.98≦f≦2.02, 0≦g≦0.02, and 0.0003≦c+d+e≦0.03), characterized by firing a mixture containing a lithium material, an aluminum material, a magnesium material, an element A material and a cobalt material containing at least one of cobalt oxyhydroxide, tricobalt tetroxide and cobalt hydroxide and as the case requires, a fluorine material in an oxygen-containing atmosphere at from 800 to 1,050° C.
(10) The process for producing a cathode active material for a lithium secondary battery according to the above
(9), wherein at least one of the aluminum material, the magnesium material and the element A material is formed into a solution and mixed with at least the cobalt material.

In the present invention, the mechanism of how the is cathode active material for a lithium secondary battery of the present invention has high safety and provides both favorable cyclic properties and high discharge voltage, is not necessarily clear but is estimated as follows. Namely, in the particulate lithium cobalt composite oxide constituting the cathode active material for a secondary battery of the present invention, all of the element A, aluminum and magnesium are added, and the entire or some of them are solid-solubilized, whereby the oxygen element in the crystal lattice is stable under a high voltage condition where lithium ions are withdrawn, and oxygen is less likely to release, and the safety will be improved resultingly. Further, by uneven presence of the element A on the surface of the positive electrode particles, the coating derived from the electrolytic solution to be formed on the positive electrode tends to be thin and as a result, the impedance of the positive electrode will be low, the discharge voltage will improve, and the durability for charge and discharge cycles will improve also.

### DETAILED DESCRIPTION OF THE PREFERRED EMBODIMENTS

The lithium cobalt oxide composite oxide constituting the cathode active material for a lithium ion secondary battery of the present invention is represented by the above-mentioned formula (1):
LiₐCo_{b}Al_{c}Mg_{d}AₑO_{f}F_{g}.

In the above formula (1), A, a, b, c, d, and e are as defined above. If each of a and b is out of the above range, the discharge capacity tends to be low, or the durability for charge and discharge cycles tends to be low, such being undesirable. If each of c, d, and e is lower than each lower limit, the effects of improving the safety, the discharge voltage and the durability for charge and discharge cycles tend to be low, such being undesirable. If each of c, d, e and g is more than each upper limit, the discharge capacity tends to be low, such being undesirable. Particularly, A is preferably titanium, and particularly preferred ranges of c, d, e and g are such that 0.0003≦c<0.01, 0.0003≦d≦0.01, 0.0002≦e<0.007, 0≦g≦0.01 and 0.0005≦c+d+e≦0.02.

Further, in the formula (1), c as the atomic ratio of Al and d as the atomic ratio of Mg are preferably such that 0.5≦c/d≦2 and 0.002≦c+d≦0.025, whereby the safety of the cathode active material will be kept and at the same time, the discharge capacity is less likely to decrease. Particularly preferably, 0.7≦c/d≦1.5 and 0.005≦c+d≦0.02.

Further, in the formula (1), the atomic ratio of the element A and the atomic ratio of Mg are preferably such that 0.01≦e/d≦1 and 0.002≦e+d≦0.02. If e/d is at most 0.01, the effect of improving the discharge voltage tends to be low, and the effect of improving the durability for charge and discharge cycles tends to be low, such being undesirable. Particularly preferably, 0.02≦e/d≦0.07 and 0.005≦e+d≦0.015.

Further, in the lithium cobalt composite oxide represented by the formula (1), at least some of Al, Mg and the element A is preferably in the form of a solid solution having cobalt atoms of the lithium cobalt composite oxide particles substituted. Further, it was found that the safety will improve when the amount of Al contained as a single oxide is small. Thus, in the present invention, the amount of Al contained as a single oxide is preferably at most 20 mol %, more preferably at most 10 mol % of the entire Al contained in the lithium cobalt composite oxide.

The cathode active material for a lithium secondary battery comprising the lithium cobalt composite oxide of the present invention is preferably in the form of spherical particles, and the average particle size (D50 determined by a laser scattering type particle size distribution analyzer, the same applies hereinafter) is preferably from 2 to 20 μm, particularly preferably from 3 to 15 μm. If the average particle size is smaller than 2 μm, it tends to be difficult to form a dense electrode layer, and on the other hand, if it exceeds 20 μm, it tends to be difficult to form a smooth electrode layer surface, such being undesirable.

Further, the above cathode active material are preferably in the form of particles comprising secondary particles formed by agglomeration of at least ten fine primary particles, whereby the packing density of the active material in the electrode layer will improve and at the same time, the large current charge and discharge properties will improve.

In the particulate cathode active material of the present invention, the element A and/or F is preferably present substantially uniformly on the surface of the particles. Here, “uniformly present” includes not only a case where the above element is substantially uniformly present in the vicinity of the surface of the particles but also a case where the amount of the above element present is equal among the particles. Only one should be satisfied, and particularly preferably both are satisfied. Namely, it is particularly preferred that the amount of the above element present is substantially equal among the particles and that the above element is uniformly present on the surface of one particle.

Further, presence of the element A and/or F on the surface of the particles being preferred means, in other words, substantially no element A or F is preferably present in the interior of the particles. In such a manner, the effect can be developed by addition of a trace amount of the element A and F. In a case where the element Al, Mg, the element A or the fluorine atom is contained in the interior of the particles, a large amount is required to develop high safety, a high discharge voltage, a large capacity and high cyclic properties. Addition in a large amount rather leads to a decrease in the initial capacity, a decrease in the large current discharge properties, and the like, and thus it is desired to add a small amount and to let the element be present only on the surface. Particularly, the element A and F are suitably present preferably within 100 nm, particularly preferably within 30 nm from the surface of the particles.

Some of Al and the element A present in the above cathode active material is preferably in the form of a solid solution having cobalt atoms in the interior of the particles substituted. Some of Mg present in the cathode active material is preferably in the form of a solid solution having lithium atoms in the interior of the particles substituted. In such cases, cobalt and oxygen atoms on the surface of the particles of the cathode active material will not be exposed, whereby the effect of the additional elements will be more achieved. It is preferred to add fluorine atoms, whereby effects of improving the safety and the cyclic properties of the battery will be achieved.

The atomic ratio of fluorine atoms to cobalt atoms (fluorine atoms/cobalt atoms) is preferably from 0.0001 to 0.02, particularly preferably from 0.0005 to 0.008 to improve the safety and the cyclic properties. If the atomic ratio of fluorine atoms is higher than this range, the decrease in the discharge capacity tends to be remarkable, such being undesirable.

Further, the particulate cathode active material of the present invention preferably has a press density of from 3.0 to 3.4 g/cm³. If the press density is smaller than 3.0 g/cm³, the initial volume capacity density of a positive electrode when a positive electrode sheet is formed by using the particulate cathode active material tends to be low. On the other hand, if it is higher than 3.4 g/cm³, the initial weight capacity density of the positive electrode tends to be low, or the high rate discharge properties tend to be low, such being undesirable. Particularly, the press density of the particulate cathode active material is preferably from 3.15 to 3.3 g/cm³. Here, the press density means a value determined from the volume and the powder weight when the powder is pressed under 0.32 t/cm².

Further, the specific surface area of the particulate cathode active material of the present invention is preferably from 0.2 to 1 m²/g. If the specific surface area is smaller than 0.2 m²/g, the initial discharge capacity per unit weight tends to be low, and on the other hand, if it exceeds 1 m²/g also, the initial discharge capacity per unit volume tends to be low, and no excellent cathode active material which is aimed at in the present invention will be obtained. The specific surface area is particularly preferably from 0.3 to 0.7 m²/g. is A process for producing the particulate cathode active material of the present invention is not necessarily limited, and production is possible by a known method. In the present invention, as a preferred example, a process of dry mixing solid powders respectively containing Al, Mg, the element A and F, with a cobalt material powder and a lithium material powder, followed by firing, may be mentioned.

In the present invention, as a method of adding Al, Mg, the element A and F to the cobalt material powder and the lithium material powder, various methods may be applicable. Namely, some or all of solid compounds respectively containing Al, Mg, the element A and F are dissolved or dispersed in an aqueous solution, an organic solvent or the like, and further an organic acid or a hydroxyl group-containing organic material each capable of forming a complex is added thereto to form a uniform solution or colloidal solution, and a cobalt material powder is impregnated with the solution, followed by drying so that Al, Mg, the element A and F are uniformly supported on the cobalt material, and then a lithium material powder is mixed, followed by firing. Otherwise, the above uniform solution or colloidal solution is mixed with a cobalt material powder and a lithium material powder, and the mixture is dried and then fired, whereby high battery performance will be achieved. In such a case, it is required to change the amount of elements to be added in some cases, since the distribution of elements in the particles is different from a case where the elements are added in a solid phase method.

As the materials used for production in the present invention, for example, the cobalt material is preferably cobalt hydroxide, tricobalt tetroxide, cobalt oxyhydroxide, particularly preferably cobalt oxyhydroxide, tricobalt tetroxide or cobalt hydroxide, with which high battery performance will be achieved. Particularly, the cobalt material is preferably substantially spherical cobalt oxyhydroxide comprising secondary particles formed by agglomeration of many primary particles, with which the press density can be increased.

Further, the cobalt material is preferably a cobalt material containing at least one of cobalt oxyhydroxide or cobalt hydroxide, in the form of particles comprising secondary particles formed by agglomeration of at least 10 primary particles, with which high battery performance will be achieved.

As the material of each of Al, Mg and the element A, preferred is an oxide, a hydroxide, a chloride, a nitrate, an organic acid salt, an oxyhydroxide or a fluoride, and particularly preferred is a hydroxide or a fluoride, with which high battery performance is likely to be obtained. The lithium material is preferably lithium carbonate or lithium hydroxide. Further, the fluorine material is preferably lithium fluoride, aluminum fluoride or magnesium fluoride.

The particulate cathode active material is produced by firing a mixture of these materials, preferably a mixture of (1) to (4) i.e. (1) an Al, element A and Mg-containing oxide or an Al, element A and Mg-containing hydroxide, (2) cobalt hydroxide, cobalt oxyhydroxide or cobalt oxide, (3) lithium carbonate and as the case requires, (4) lithium fluoride, in an oxygen-containing atmosphere at from 600 to 1,050° C., preferably from 850 to 1,000°C. preferably for from 4 to 48 hours, particularly preferably from 8 to 20 hours to convert the mixture into a composite oxide. Further, an Al, element A or Mg-containing fluoride may be used instead of the element A and lithium fluoride.

The oxygen-containing atmosphere is preferably an oxygen-containing atmosphere having an oxygen concentration of preferably at least 10 vol %, particularly preferably at least 40 vol %. By such a composite oxide, by changing the type of the above materials, the composition of the mixture and the firing conditions, the above-described present invention can be satisfied. Further, in the present invention, prior to firing, pre-firing may be carried out. The pre-firing is suitably carried out in an oxidizing atmosphere preferably at from 450 to 550° C. preferably for from 4 to 20 hours.

Further, production of the cathode active material is of the present invention is not necessarily limited to the above process, and for example, production is possible by preparing a cathode active material employing a metal fluoride, oxide and/or hydroxide as the material, followed by surface treatment with a fluorinating agent such as fluorine gas, NF₃ or HF.

A method to obtain a positive electrode for a lithium secondary battery from the particulate cathode active material of the present invention can be carried out in accordance with a known method. For example, a cathode mixture is formed by mixing the powder of the cathode active material of the present invention with a carbon type electroconductive material such as acetylene black, graphite or Ketjenblack and a binder material. As such a binder material, polyvinylidene fluoride, polytetrafluoroethylene, polyamide, carboxymethyl cellulose or an acrylic resin may, for example, be used.

The above cathode mixture is dispersed in a dispersion medium such as N-methylpyrrolidone to prepare a slurry, which is applied to a cathode current collector such as an aluminum foil and dried and pressed to form a cathode active material layer on the cathode current collector.

For the lithium battery employing the cathode active material of the present invention as the positive electrode, the solvent of the electrolytic solution is preferably a carbonate ester. As the carbonate ester, each of a cyclic type and a chain type can be used. As the cyclic carbonate ester, propylene carbonate or ethylene carbonate (EC) may, for example, be mentioned. As the chain carbonate ester, dimethyl carbonate, diethyl carbonate (DEC), ethyl methyl carbonate, methyl propyl carbonate or methyl isopropyl carbonate may, for example, be mentioned.

The carbonate ester may be used alone or by mixing at least two types. Further, it may be used by mixing with another solvent. Further, according to the material of the anode active material, if the chain carbonate ester is used together with the cyclic carbonate ester, there is a case where the discharge properties, the cyclic durability or the charge and discharge efficiency can be improved.

Further, to such an organic solvent, a vinylidene fluoride-hexafluoropropylene copolymer (for example, KYNAR manufactured by ELF Atochem) or a vinylidene fluoride-perfluoropropyl vinyl ether copolymer is added and the following solute is added to prepare a gel polymer electrolyte.

As the solute in the electrolytic solution, at least one member of lithium salts is preferably used, wherein e.g. C10₄⁻, CF₃SO₃⁻, BF₄⁻, PF₆⁻, AsF₆⁻, SbF₆⁻CF₃CO₂⁻ or (CF₃SO₂)₂N⁻ is anion. The electrolyte comprising a lithium salt is preferably added at a concentration of from 0.2 to 2.0 mol/L to the solvent or the solvent-containing polymer to prepare the above electrolytic solution or polymer electrolyte. If the concentration deviates from this range, ionic conductivity will decrease, and the electrical conductivity of the electrolyte will decrease. More preferably, it is from 0.5 to 1.0 mol/L. As a separator, a porous polyethylene or a porous polypropylene film may be used.

The anode active material of the lithium battery using the cathode active material of the present invention as the positive electrode, is a material which can occlude and discharge lithium ions. The material forming the anode active material is not particularly limited, however, lithium metal, a lithium alloy, a carbon material, an oxide comprising, as a main body, a material of Group 14 or Group 15 of the Periodic Table, a carbon compound, a silicon carbide compound, a silicon oxide compound, titanium sulfide or a boron carbide compound may, for example, be mentioned.

As the carbon material, an organic material which is subjected to thermal decomposition under various thermal decomposition conditions, artificial graphite, natural graphite, soil graphite, exfoliated graphite or flake graphite etc. can be used. Further, as the oxide, a compound comprising tin oxide as a main body can be used. As the anode current collector, a copper foil, a nickel foil etc. can be used.

The shape of the lithium secondary battery using the is cathode active material of the present invention is not particularly limited. Sheet (so-called film), folding, winding type cylinder with bottom or button shape etc. is selected according to use.

Now, the present invention will be described in further detail with reference to Examples 1 to 7 and Comparative Examples 1 to 3. However, it should be understood that the present invention is by no means restricted to such specific Examples.

In the following Examples, the high sensitivity X-ray diffraction spectrum means a diffraction spectrum obtained at an accelerating voltage of 50 KV at an accelerating current of 250 mA of an X-ray tube. A conventional X-ray diffraction spectrum is obtained about at 40 KV at an accelerating current of 40 mA, with which it is difficult to detect a trace amount of impurity phase which is noted in the present invention and which has significant influence over the battery performance with high accuracy in a short time with suppressed analysis noise.

### EXAMPLE 1

A cobalt hydroxide powder having an average particle size D50 of 13.2 μm comprising secondary particles formed by agglomeration of at least 50 primary particles, a lithium carbonate powder having an average particle size of 15 μm, an aluminum hydroxide powder having a particle size of 1.5 μm, a magnesium hydroxide powder having an average particle size of 3.7 μm and a titanium oxide powder having an average particle size of 0.6 μm each in a predetermined amount were mixed. After these four types of powders were dry-mixed, the mixture was fired in the air at 400° C. for 3 hours and then fired at 950° C. for 10 hours. The powder after firing was wet dissolved and subjected to ICP and atomic absorption analysis to determine contents of cobalt, aluminum, magnesium, titanium and lithium and as a result, the powder had a composition of LiCo_{0.9975}Al_{0.001}Mg_{0.00}Ti_{0.0005}O₂.

The powder (cathode active material powder) after firing had a specific surface area of 0.37 m²/g as determined by a nitrogen adsorption method and an average particle size D50 of 13.8 μm. As a result of XPS analysis of the surface of the powder after firing, an intense signal of Al2P attributable to aluminum and an intense signal of Ti2P attributable to titanium were detected. Further, the positive electrode powder had a press density of 3.25 g/cm³.

Further, this powder was subjected to sputtering for 10 minutes and then subjected to XPS analysis, whereupon signals of aluminum and titanium by XPS attenuated to 10% and 13% of the signals before sputtering, respectively. This sputtering corresponds to the surface etching to a depth of about 30 nm. Thus, presence of aluminum and titanium on the surface of the particles was confirmed. Further, as a result of observation by SEM (scanning electron microscope), the obtained cathode active material powder comprised secondary particles formed by agglomeration of at least 30 primary particles. The powder after firing was subjected to high sensitivity X-ray diffraction analysis using Cu—Kα rays by using an X-ray diffraction apparatus (RINT 2500 model, manufactured by Rigaku Corporation) at an accelerating voltage of 50 KV at an accelerating current of 250 mA at a scanning rate of 1°/min with a step angle of 0.02° with a divergence slit of 1° with a scattering slit of 1°with a receiving slit of 0.3 mm with monochromatization to obtain an X-ray diffraction spectrum. As a result, it was found that aluminum was not present as a single oxide.

The LiCo_{0.9975}Al_{0.001}Mg_{0.001}Ti_{0.0005}O₂ powder thus obtained, acetylene black and a polytetrafluoroethylene powder were mixed in a weight ratio of 80/16/4, kneaded while toluene was added, and dried to prepare a positive electrode plate having a thickness of 150 μm.

Using an aluminum foil having a thickness of 20 μm as a cathode current collector, using a porous polypropylene having a thickness of 25 μm as a separator, using a metal lithium foil having a thickness of 500 μm as a negative electrode, using a nickel foil of 20 μm as an anode current collector and using 1M LiPF₆/EC+DEC (1:1) as an electrolytic solution, a simplified sealed cell (battery) made of stainless steel was assembled in an argon glove box.

The battery was charged up to 4.3 V at a load current of 75 mA per 1 g of the cathode active material at 25° C. and discharged down to 2.75 V at a load current of 75 mA per 1 g of the cathode active material, whereby the initial discharge capacity was obtained. Further, a cyclic charge and discharge test was carried out 14 times.

The initial discharge capacity at 25° C. at from 2.75 to 4.3 V at a discharge rate of 0.5 C was 161.5 mAh/g, and the average voltage was 3.976 V. The capacity retention was 99.3% after 14 times of charge and discharge cycle.

Further, another battery was prepared in the same manner. This battery was charged at 4.3 V for 10 hours and then disassembled in the argon glove box, and the positive electrode sheet after charge was taken out, and after the positive electrode sheet was washed, it was punched out at a diameter of 3 mm and then sealed in an aluminum capsule with EC. And then, it was heated at a rate of 5° C./min by using a scanning differential calorimetry, whereby the heat generation starting temperature was measured. As a result, the heat generation starting temperature of the 4.3 V charged material was 167° C.

### EXAMPLE 2

A cathode active material was prepared in the same manner as in Example 1 except that niobium oxide was used instead of titanium oxide, and composition analysis, measurement of physical properties and the test on battery performance were carried out. As a result, the composition was LiCo_{0.9975}Al_{0.001}Mg_{0.001}Nb_{0.0005}O₂.

Further, the powder after firing had a specific surface area of 0.32 m²/g as determined by a nitrogen adsorption method and an average particle size D50 of 13.5 μm as determined by a laser scattering type particle size distribution analyzer. Aluminum and niobium were present on the surface. The initial discharge capacity at 25° C. at from 2.75 to 4.3 V at a discharge rate of 0.5 C was 162.0 mAh/g, and the average voltage was 3.974 V. The capacity retention was 99.2% after 14 times of charge and discharge cycle. The heat generation starting temperature was 165° C. The positive electrode powder had a press density of 3.26 g/cm³.

The powder after firing was subjected to high sensitivity X-ray diffraction analysis using Cu—Kα rays by using an X-ray diffraction apparatus (RINT 2500 model, manufactured by Rigaku Corporation) at an accelerating voltage of 50 KV at an accelerating current of 250 mA at a scanning rate of 1°/min with a step angle of 0.02° with a divergence slit of 1° with a scattering slit of 1° with a receiving slit of 0.3 mm with monochromatization to obtain an X-ray diffraction spectrum. As a result, it was found that aluminum was not present as a single oxide.

### EXAMPLE 3

A cathode active material was prepared in the same is manner as in Example 1 except that tantalum oxide was used instead of titanium oxide, and composition analysis, measurement of physical properties and the test on battery performance were carried out. As a result, the composition was LiCo_{0.9975}Al_{0.001}Mg_{0.001}Ta_{0.0005}O₂.

Further, the powder after firing had a specific surface area of 0.30 m²/g as determined by a powder nitrogen adsorption method and an average particle size D50 of 13.3 μm as determined by a laser scattering type particle size distribution analyzer. Aluminum and tantalum were present on the surface. The initial discharge capacity at 25° C. at from 2.75 to 4.3 V at a discharge rate of 0.5 C was 161.8 mAh/g, and the average voltage was 3.974 V. The capacity retention was 99.2% after 14 times of charge and discharge cycle. The heat generation starting temperature was 165° C. The positive electrode powder had a press density of 3.24 g/cm³.

The powder after firing was subjected to high sensitivity X-ray diffraction analysis using Cu—Kα rays by using an X-ray diffraction apparatus (RINT 2500 model, manufactured by Rigaku Corporation) at an accelerating voltage of 50 KV at an accelerating current of 250 mA at a scanning rate of 1°/min with a step angle of 0.02° with a divergence slit of 1° with a scattering slit of 1° with a receiving slit of 0.3 mm with monochromatization to obtain an X-ray diffraction spectrum. As a result, it was found that aluminum was not present as a single oxide.

### EXAMPLE 4

A cathode active material was prepared in the same manner as in Example 1 except that a cobalt oxyhydroxide powder having an average particle size D50 of 10.7 μm comprising secondary particles formed by agglomeration of at least 50 primary particles, a lithium carbonate powder, an aluminum hydroxide powder, a magnesium hydroxide powder, a titanium oxide powder and a lithium fluoride powder each in a predetermined amount were mixed, and composition analysis, measurement of physical properties and the test on battery performance were carried out. As a result, the composition was LiCo_{0.9975}Al_{0.001}Mg_{0.001}Ti_{0.0005}O_{1.993}F_{0.007}

Further, the powder after firing had a specific surface area of 0.34 m²/g as determined by a powder nitrogen adsorption method and an average particle size D50 of 12.9 μm as determined by a laser scattering type particle size distribution analyzer. Aluminum, titanium and fluorine were present on the surface. Further, as a result of observation by SEM, the obtained cathode active material powder comprised secondary particles formed by agglomeration of at least 30 primary particles. Further, the positive electrode powder had a press density of 3.23 g/cm³.

The initial discharge capacity at 25° C. at from 2.75 to 4.3 V at a discharge rate of 0.5 C was 161.5 mAh/g, and the average voltage was 3.976 V. The capacity retention was 99.3% after 14 times of charge and discharge cycle. Further, the heat generation starting temperature of the 4.3 V charged material was 170° C.

### COMPARATIVE EXAMPLE 1

A cathode active material was prepared in the same manner as in Example 1 except that the aluminum hydroxide powder, the magnesium hydroxide powder and the titanium oxide powder were not used, and composition analysis, measurement of physical properties and the test on battery performance were carried out. As a result, the composition was LiCoO₂.

Further, the powder after firing had a specific surface area of 0.32 m²/g as determined by a nitrogen adsorption method and an average particle size D50 of 13.4 μm as determined by a laser scattering type particle size distribution analyzer. Further, the positive electrode powder had a press density of 3.25 g/cm³.

The initial discharge capacity at 25° C. at from 2.75 to 4.3 V at a discharge rate of 0.5 C was 161.9 mAh/g, and the average voltage was 3.961 V. The capacity retention was 97.8% after 14 times of charge and discharge cycle. Further, the heat generation starting temperature of the 4.3 V charged material was 160° C.

### COMPARATIVE EXAMPLE 2

A cathode active material was prepared in the same manner as in Example 1 except that titanium oxide was not used, and composition analysis, measurement of physical properties and the test on battery performance were carried out. As a result, the composition was LiCo_{0.998}A1_{0.001}Mg_{0.001}O₂.

Further, the powder after firing had a specific surface area of 0.34 m²/g as determined by a nitrogen adsorption method and an average particle size D50 of 13.2 μm as determined by a laser scattering type particle size distribution analyzer. Aluminum was present on the surface. Further, the positive electrode powder had a press density of 3.25 g/cm³.

The initial discharge capacity at 25° C. at from 2.75 to 4.3 V at a discharge rate of 0.5 C was 161.0 mAh/g, and the average voltage was 3.964 V. The capacity retention was 98.7% after 14 times of charge and discharge cycle. Further, the heat generation starting temperature of the 4.3 V charged material was 167° C.

### COMPARATIVE EXAMPLE 3

A cathode active material was prepared in the same manner as in Example 1 except that magnesium hydroxide was not used, and composition analysis, measurement of physical properties and the test on battery performance were carried out. As a result, the composition was LiCo_{0.9985}Al_{0.001}Mg_{0.0005}O₂.

Further, the powder after firing had a specific surface area of 0.30 m²/g as determined by a nitrogen adsorption method and an average particle size D50 of 13.5 μm as determined by a laser scattering type particle size distribution analyzer. Aluminum was present on the surface. Further, the positive electrode powder had a press density of 3.24 g/cm³.

The initial discharge capacity at 25° C. at from 2.75 to 4.3 V at a discharge rate of 0.5 C was 160.2 mAh/g, and the average voltage was 3.974 V. The capacity retention was 98.5% after 14 times of charge and discharge cycle. The heat generation starting temperature was 163° C.

### EXAMPLE 5

A cathode active material was prepared in the same manner as in Example 1 except that addition amounts of aluminum hydroxide, magnesium hydroxide and titanium oxide were changed, and composition analysis, measurement of physical properties and the test on battery performance were carried out. As a result, the composition was LiCo_{0.9952}Al_{0.002}Mg_{0.002}Ti_{0.0008}O₂.

Further, the powder after firing had a specific surface area of 0.33 m²/g as determined by a nitrogen adsorption method and an average particle size D50 of 13.5 μm as determined by a laser scattering type particle size distribution analyzer. Aluminum and titanium were present on the surface. The initial discharge capacity at 25° C. at from 2.75 to 4.3 V at a discharge rate of 0.5 C was 160.0 mAh/g, and the average voltage was 3.976 V. The capacity retention was 99.5% after 14 times of charge and discharge cycle. The heat generation starting temperature was 170° C. The positive electrode powder had a press density of 3.20 g/cm³.

### EXAMPLE 6

1.97 g of a magnesium carbonate powder, 2.88 g of citric acid and 133.20 g of water were mixed, and 1.50 g of ammonia was added thereto to prepare an aqueous solution of a salt of carboxylic acid having magnesium uniformly dissolved and having a pH of 9.5. The aqueous solution was added to 193.4 g of cobalt hydroxide having an average particle size D50 of 13.5 μm, D10 of 5.5 μm and D90 of 18.1 μm to prepare a slurry. The solid content concentration in the slurry was 76 wt %.

This slurry was dehydrated in a dryer at 120° C. for 2 hours to obtain a cobalt hydroxide powder having magnesium added.

With the cobalt hydroxide powder having magnesium added, 1.53 g of aluminum hydroxide, 0.08 g of titanium oxide and 74.5 g of lithium carbonate were mixed, followed by firing in the air at 950° C. for 12 hours to obtain LiCo_{0.9795}Al_{0.01}Mg_{0.01}Ti_{0.0005}O₂.

The powder after firing had a specific surface area of 0.35 m²/g as determined by a nitrogen adsorption method and an average particle size D50 of 13.3 μm as determined by a laser scattering type particle size distribution analyzer. Magnesium was uniformly present in the particles, but aluminum and titanium were present on the surface. The initial discharge capacity at 25° C. at from 2.75 to 4.3 V at a discharge rate of 0.5 C was 161.1 mAh/g, and the average voltage was 3.975 V. The capacity retention after 14 times of charge and discharge cycle was 99.3%. The heat generation starting temperature was 167° C. The positive electrode powder had a press density of 3.21 g/cm³.

### EXAMPLE 7

1.97 g of a magnesium carbonate powder, 3.13 g of aluminum lactate, 5.34 g of citric acid and 130.07 g of water were mixed, and 1.50 g of ammonia was added thereto to prepare an aqueous solution of a salt of carboxylic acid having magnesium and aluminum uniformly dissolved and having a pH of 9.5. The aqueous solution was added to 195.0 g of cobalt hydroxide having an average particle size D50 of 13.5 μm, D10 of 5.5 μm and D90 of 18.1 μm to prepare a slurry. The solid content concentration in the slurry was 76 wt %.

This slurry was dehydrated in a dryer at 120° C. for 2 hours to obtain a cobalt hydroxide powder having magnesium and aluminum added. With the cobalt hydroxide powder having magnesium and aluminum added, 0.08 g of titanium oxide and 74.5 g of lithium carbonate were mixed, followed by firing in the air at 950° C. for 12 hours to obtain LiCo_{0.9795}Al_{0.01}Mg_{0.01}Ti_{0.0005}O₂.

The powder after firing had a specific surface area of 0.33 m²/g as determined by a nitrogen adsorption method and an average particle size D50 of 13.7 μm as determined by a laser scattering type particle size distribution analyzer. Magnesium and aluminum were uniformly present in the particles, but titanium was present on the surface. The initial discharge capacity at 25° C. at from 2.75 to 4.3 V at a discharge rate of 0.5 C was 162.0 mAh/g, and the average voltage was 3.977 V. The capacity retention after 14 times of charge and discharge cycle was 99.6%. The heat generation starting temperature was 169° C. The positive electrode powder had a press density of 3.23 g/cm³.

According to the present invention, a cathode material for a lithium ion secondary battery, useful for a lithium ion secondary battery which has a high discharge voltage, a large capacity, high cyclic durability and high safety, can be provided.

The entire disclosure of Japanese Patent Application No. 2004-212078 filed on Jul. 20, 2004 including specification, claims, drawings and summary is incorporated herein by reference in its entirety.

What is claimed is:

1. A cathode active material for a lithium secondary battery, characterized by comprising a particulate lithium cobalt composite oxide represented by the formula
LiₐCO_{b}Al_{c}Mg_{d}AₑO_{f}F_{g} (1)
(wherein A is Ti, Nb or Ta, 0.90≦a≦1.10, 0.97≦b≦1.00, 0.0001≦c≦0.02, 0.0001≦d≦0.02, 0.0001≦e≦0.01, 1.98≦f≦2.02, 0≦g≦0.02, and 0.0003≦c+d+e≦0.03).

2. The cathode active material for a lithium secondary battery according to claim 1, wherein in the formula (1), 0.5≦c/d≦2, and 0.002≦c+d≦0.025.

3. The cathode active material for a lithium secondary battery according to claim 1, wherein in the formula (1), 0.01≦e/d≦1, and 0.002≦e+d≦0.02.

4. The cathode active material for a lithium secondary battery according to claim 2, wherein in the formula (1), 0.01≦e/d≦1, and 0.002≦e+d≦0.02.

5. The cathode active material for a lithium secondary battery according to claim 1, wherein the element A is present on the surface of the particulate lithium cobalt composite oxide.

6. The cathode active material for a lithium secondary battery according to claim 4, wherein in the formula (1), 0.01≦e/d≦1, and 0.002≦e+d≦0.02.

7. The cathode active material for a lithium secondary battery according to claim 1, wherein the element F is present on the surface of the particulate lithium cobalt composite oxide.

8. The cathode active material for a lithium secondary battery according to claim 1, wherein at least some of Al, Mg and the element A is in the form of a solid solution having cobalt atoms of the lithium cobalt composite oxide particles substituted.

9. The cathode active material for a lithium secondary battery according to claim 1, wherein the amount of Al contained as a single oxide is at most 20 mol% of the entire Al contained in the lithium cobalt composite oxide.

10. The cathode active material for a lithium secondary battery according to claim 4, wherein the amount of Al contained as a single oxide is at most 20 mol% of the entire Al contained in the lithium cobalt composite oxide.

11. The cathode active material for a lithium secondary battery according to claim 5, wherein the amount of Al contained as a single oxide is at most 20 mol% of the entire Al contained in the lithium cobalt composite oxide.

12. The cathode active material for a lithium secondary battery according to claim 1, wherein the particulate lithium cobalt composite oxide has a press density of from 3.0 to 3.4 g/cm³.

13. The cathode active material for a lithium secondary battery according to claim 4, wherein the particulate lithium cobalt composite oxide has a press density of from 3.0 to 3.4 g/cm³.

14. The cathode active material for a lithium secondary battery according to claim 11, wherein the particulate lithium cobalt composite oxide has a press density of from 3.0 to 3.4 g/cm³.

15. A process for producing a cathode active material for a lithium secondary battery comprising a particulate lithium cobalt composite oxide represented by the formula
LiₐCO_{b}Al_{c}Mg_{d}AₑO_{f}F_{g} (1)
(wherein A is Ti, Nb or Ta, 0.90≦a≦1.10, 0.97≦b≦1.00, 0.0001≦c≦0.02, 0.0001≦d≦0.02, 0.0001≦e≦0.01, 1.98≦f≦2.02, 0≦g≦0.02, and 0.0003≦c+d+e≦0.03), characterized by firing a mixture containing a lithium material, an aluminum material, a magnesium material, an element A material and a cobalt material containing at least one of cobalt oxyhydroxide, tricobalt tetroxide and cobalt hydroxide and as the case requires, a fluorine material in an oxygen-containing atmosphere at from 800 to 1,050° C.

16. The process for producing a cathode active material for a lithium secondary battery according to claim 15, wherein at least one of the aluminum material, the magnesium material and the element A material is formed into a solution and mixed with at least the cobalt material.
